(19) United States
(12) Patent Application Publication
(10) Pub. No.: US 2024/0049254 A1
(43) Pub. Date: Feb. 8, 2024

(54) DOWNLINK MULTICAST RECEPTION FOR INACTIVE MODE USER EQUIPMENT

(71) Applicant: QUALCOMM Incorporated, San Diego, CA (US)

(72) Inventors: Le LIU, San Jose, CA (US); Alberto RICO ALVARINO, San Diego, CA (US); Prasad Reddy KADIRI, San Diego, CA (US); Peter GAAL, San Diego, CA (US); Kazuki TAKEDA, Tokyo (JP); Wanshi CHEN, San Diego, CA (US); Umesh PHUYAL, San Diego, CA (US)

(21) Appl. No.: 17/817,331

(22) Filed: Aug. 3, 2022

(51) Int. Cl. H04W 72/00; H04W 72/04; H04L 5/00; H04W 76/27

(52) U.S. Cl. CPC H04W 72/005; H04W 72/048; H04L 5/0053; H04W 76/27

(57) ABSTRACT

Various aspects of the present disclosure generally relate to wireless communication. In some aspects, a user equipment (UE) may transmit capability information regarding at least one of a multicast physical downlink shared channel (PDSCH) communication for an inactive mode or a multicast physical downlink control channel (PDCCH) communication for the inactive mode. The UE may receive a configuration associated with the multicast PDCCH communication. The UE may receive the multicast PDCCH communication in accordance with the configuration. The UE may receive the multicast PDSCH communication in the inactive mode based at least in part on the multicast PDCCH communication, wherein at least one of the configuration, or the multicast PDSCH communication is based at least in part on the capability information. Numerous other aspects are described.

### FIELD OF THE DISCLOSURE

Aspects of the present disclosure generally relate to wireless communication and to techniques and apparatuses for downlink multicast reception for an inactive mode user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

A radio access technology (RAT), such as 5G/NR (among other examples), may support unicast communication, broadcast communication, and/or multicast communication. Unicast communication is communication between one transmitting device (e.g., a network node or a UE) and one receiving device (e.g., a network node or a UE). Unicast communication may be referred to as point-to-point (PTP) communication, whereas broadcast communication and multicast communication may be referred to as point-to-multipoint (PTM) communication. Multicast communication may be considered a “one-to-many” form of communication in which a single transmitting device (e.g., a UE or a network node) transmits a communication to multiple receiving devices (e.g., UEs, network nodes, or a combination thereof). Multicast communications may be associated with a group identifier that identifies a group of recipient devices, such as a group of UEs, to which a multicast communication is directed. For example, the group identifier may be a group radio network temporary identifier (G-RNTI), in some examples. A broadcast communication may be directed to all UEs within a coverage area, all UEs associated with a cell, or the like.

Multicast communications directed to a UE in connected mode may have well-defined capabilities, features, and configurations. For example, a UE in connected mode (e.g., radio resource control (RRC) active mode) may have a well-defined physical downlink control channel (PDCCH) configuration, physical downlink shared channel (PDSCH) configuration, reliability features, and semi-persistent scheduling (SPS) configuration. Furthermore, broadcast communications may be supported in connected mode (e.g., RRC active mode), inactive mode (e.g., RRC inactive mode), and idle mode (e.g., RRC idle mode). However, there are currently no specified or well-defined capabilities, features, and configurations for multicast communications to a UE in inactive mode. Furthermore, inactive mode may present challenges that are not applicable to connected mode, such as a lower ability to transmit data to the network or receive data from the network. Between connected mode and idle mode, the UE can stay in inactive mode without completely releasing the RRC when there is no traffic and can quickly switch back to connected mode when necessary. Thus, a set of capabilities, features, and configurations for multicast communication in connected mode may not be universally applicable for multicast communication in inactive mode.

Some techniques described herein provide capabilities, features, and configurations for reception, by a UE, of multicast communications in an RRC inactive mode (e.g., RRC inactive mode). For example, some techniques described herein provide signaling of UE capabilities for multicast communication in inactive mode. Some techniques described herein provide configurations for multicast communication in inactive mode, such as PDCCH configurations (e.g., control resource set (CORESET) configurations, search space configurations, downlink control information (DCI) formats), PDSCH configurations (e.g., multiplexing and rate matching), reliability features (e.g., retransmission and feedback), SPS configurations, and/or whether multicast can be supported in a secondary cell. Thus, multicast communication can be extended to UEs in inactive mode, which improves network performance and efficiency.

Some aspects described herein relate to a method of wireless communication performed by a user equipment (UE). The method may include transmitting capability information regarding at least one of a multicast PDSCH communication for an inactive mode or a multicast PDCCH communication for the inactive mode. The method may include receiving a configuration associated with the multicast PDCCH communication. The method may include receiving the multicast PDCCH communication in accordance with the configuration. The method may include receiving the multicast PDSCH communication in the inactive mode based at least in part on the multicast PDCCH communication, wherein at least one of the configurations, or the multicast PDSCH communication is based at least in part on the capability information.

Some aspects described herein relate to a UE for wireless communication. The user equipment may include a memory and one or more processors coupled to the memory. The one or more processors may be configured to transmit capability information regarding at least one of a multicast PDSCH communication for an inactive mode or a multicast PDCCH communication for the inactive mode. The one or more processors may be configured to receive a configuration associated with the multicast PDCCH communication. The one or more processors may be configured to receive the multicast PDCCH communication in accordance with the configuration. The one or more processors may be configured to receive the multicast PDSCH communication in the inactive mode based at least in part on the multicast PDCCH communication, wherein at least one of the configuration, or the multicast PDSCH communication is based at least in part on the capability information.

Some aspects described herein relate to a non-transitory computer-readable medium that stores a set of instructions for wireless communication by a UE. The set of instructions, when executed by one or more processors of the UE, may cause the UE to transmit capability information regarding at least one of a multicast PDSCH communication for an inactive mode or a multicast PDCCH communication for the inactive mode. The set of instructions, when executed by one or more processors of the UE, may cause the UE to receive a configuration associated with the multicast PDCCH communication. The set of instructions, when executed by one or more processors of the UE, may cause the UE to receive the multicast PDCCH communication in accordance with the configuration. The set of instructions, when executed by one or more processors of the UE, may cause the UE to receive the multicast PDSCH communication in the inactive mode based at least in part on the multicast PDCCH communication, wherein at least one of the configuration, or the multicast PDSCH communication is based at least in part on the capability information.

Some aspects described herein relate to an apparatus for wireless communication. The apparatus may include means for transmitting capability information regarding at least one of a multicast PDSCH communication for an inactive mode or a multicast PDCCH communication for the inactive mode. The apparatus may include means for receiving a configuration associated with the multicast PDCCH communication. The apparatus may include means for receiving the multicast PDCCH communication in accordance with the configuration. The apparatus may include means for receiving the multicast PDSCH communication in the inactive mode based at least in part on the multicast PDCCH communication, wherein at least one of the configurations, or the multicast PDSCH communication is based at least in part on the capability information.

Some aspects described herein relate to a method of wireless communication performed by a network node. The method may include outputting a multicast PDCCH communication for a UE in accordance with a configuration associated with the multicast PDCCH communication. The method may include outputting a multicast PDSCH communication for the UE in the inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication.

Some aspects described herein relate to a network node for wireless communication. The network node may include a memory and one or more processors coupled to the memory. The one or more processors may be configured to output a multicast PDCCH communication for a UE in accordance with a configuration associated with the multicast PDCCH communication. The one or more processors may be configured to output a multicast PDSCH communication for the UE in the inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication.

Some aspects described herein relate to a non-transitory computer-readable medium that stores a set of instructions for wireless communication by a network node. The set of instructions, when executed by one or more processors of the network node, may cause the network node to output a multicast PDCCH communication for a UE in accordance with a configuration associated with the multicast PDCCH communication. The set of instructions, when executed by one or more processors of the network node, may cause the network node to output a multicast PDSCH communication for the UE in the inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication.

Some aspects described herein relate to an apparatus for wireless communication. The apparatus may include means for outputting a multicast PDCCH communication for a UE in accordance with a configuration associated with the multicast PDCCH communication. The apparatus may include means for outputting a multicast PDSCH communication for the UE in the inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example of a wireless network (e.g., wireless network) in which a UE (e.g., a UE) may support communication modes, in accordance with the present disclosure.

FIG. 5 is a diagram illustrating an example of signaling associated with a multicast physical downlink shared channel (PDSCH) communication in inactive mode, in accordance with the present disclosure.

FIG. 6 is a diagram illustrating an example process performed, for example, by a UE, in accordance with the present disclosure.

FIG. 7 is a diagram of an example apparatus for wireless communication, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

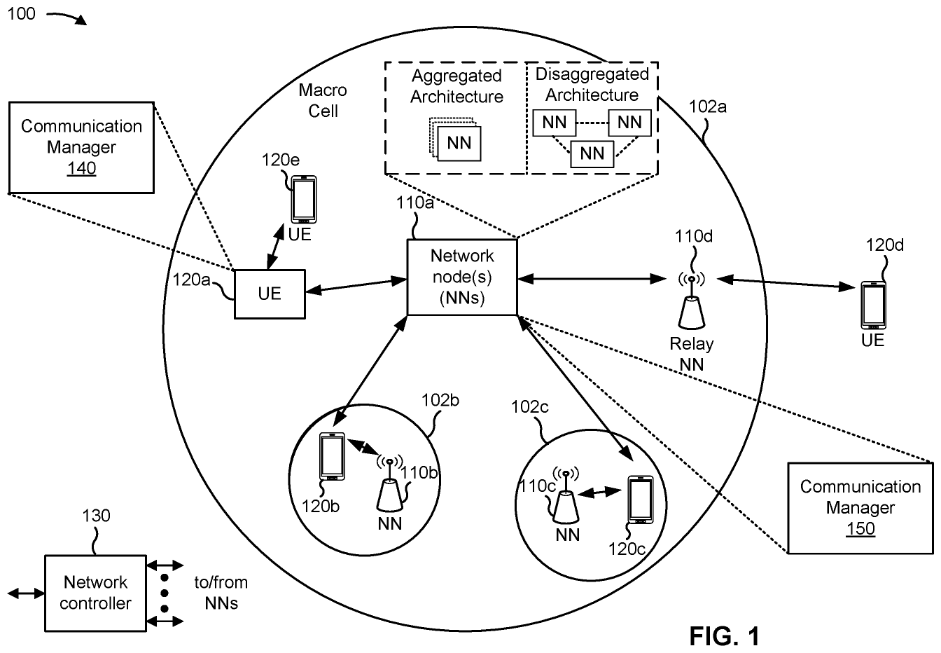

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (Dus), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more Cus, and/or one or more Dus. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) MC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit capability information regarding at least one of a multicast physical downlink shared channel (PDSCH) communication for an inactive mode or a multicast physical downlink control channel (PDCCH) communication for the inactive mode; receive a configuration associated with the multicast PDCCH communication; receive the multicast PDCCH communication in accordance with the configuration; and receive the multicast PDSCH communication in the inactive mode based at least in part on the multicast PDCCH communication, wherein at least one of the configuration, or the multicast PDSCH communication is based at least in part on the capability information. Additionally, or alternatively, the communication manager 140 may perform one or more other operations described herein.

In some aspects, the network node 110 may include a communication manager 150. As described in more detail elsewhere herein, the communication manager 150 may output a multicast PDCCH communication for a UE in accordance with a configuration associated with the multicast PDCCH communication; and output a multicast PDSCH communication for the UE in the inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication. Additionally, or alternatively, the communication manager 150 may perform one or more other operations described herein.

As indicated above, FIG. 1 is provided as an example. Other examples may differ from what is described with regard to FIG. 1.

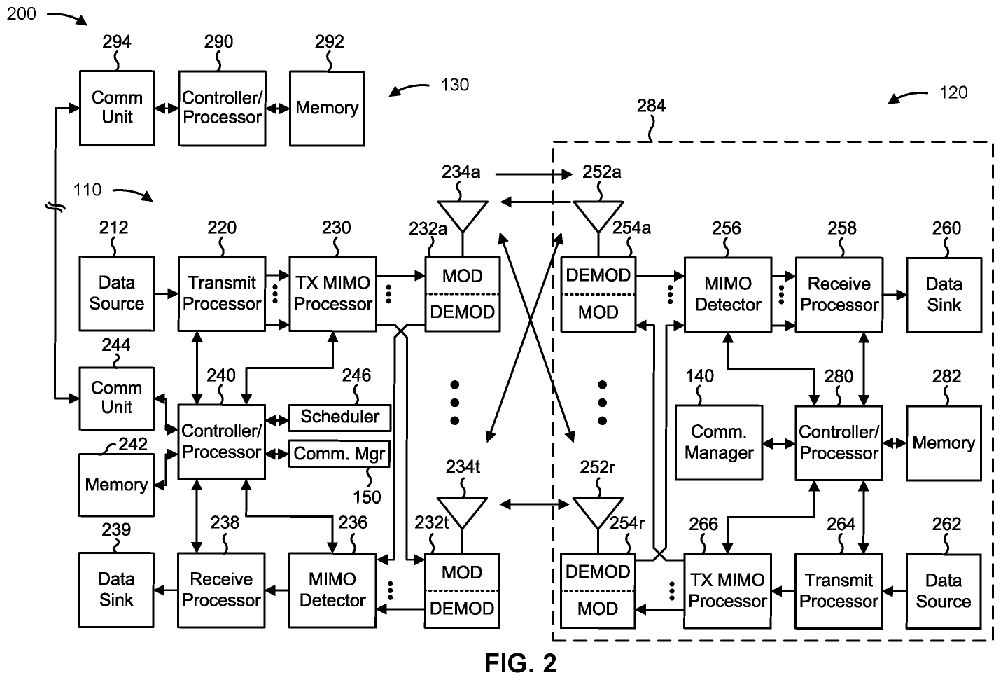

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

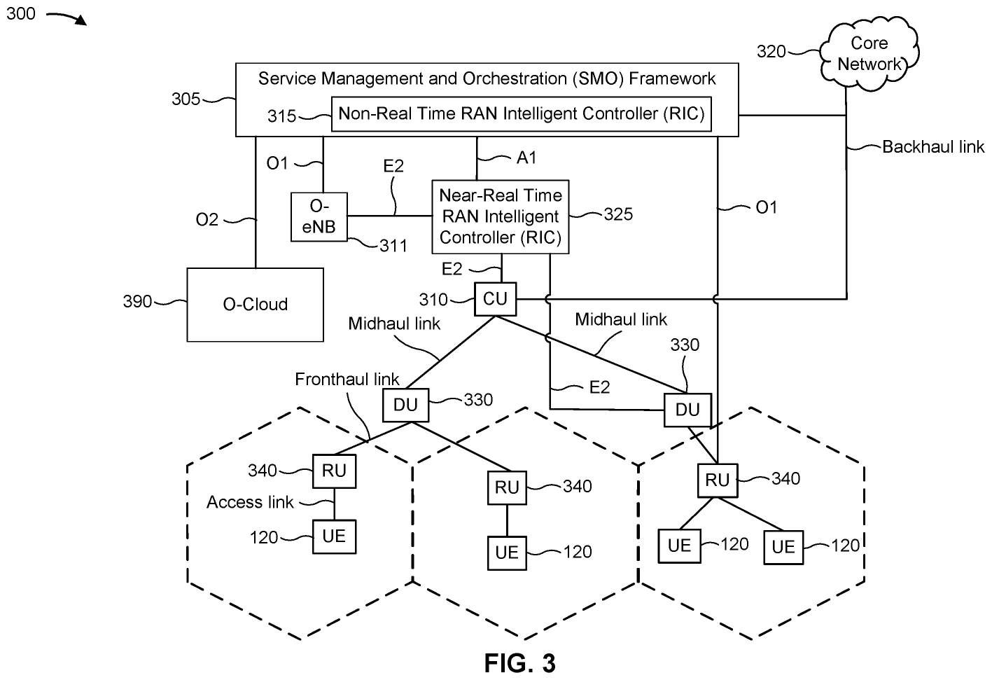

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-9).

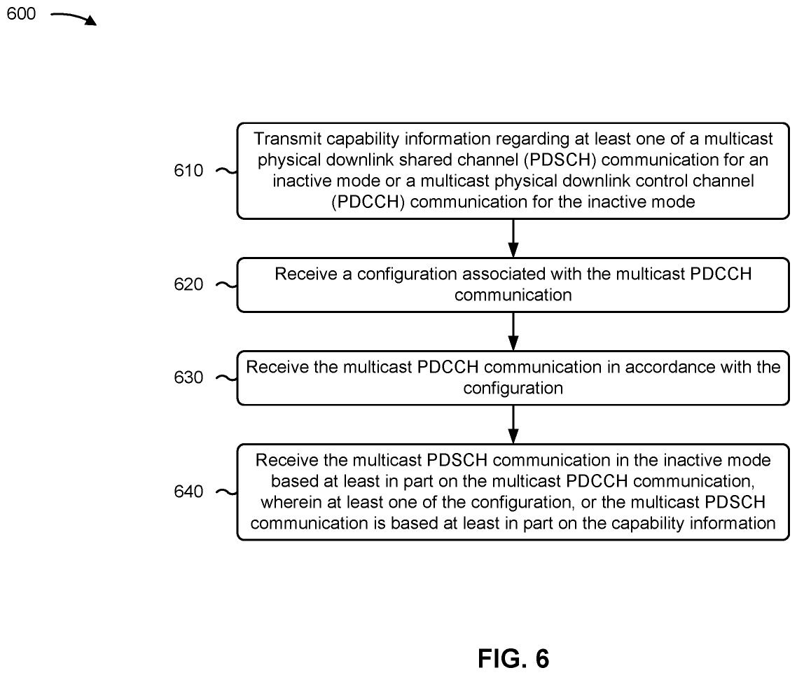

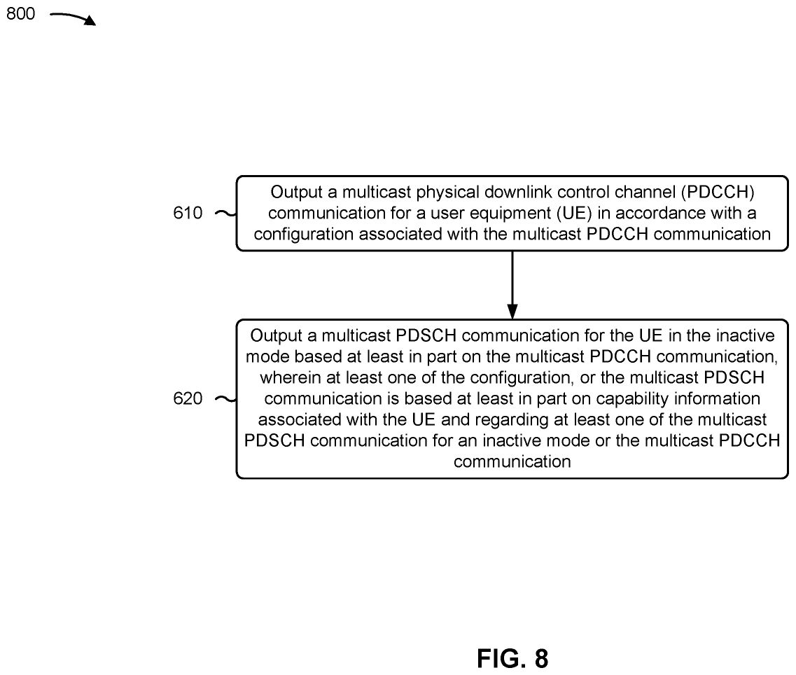

The controller/processor 240 of the network node 110, the controller/processor 280 of the UE 120, and/or any other component(s) of FIG. 2 may perform one or more techniques associated with multicast PDSCH transmission, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 800 of FIG. 8, and/or other processes as described herein. In some examples, executing instructions may include running the instructions, converting the instructions, compiling the instructions, and/or interpreting the instructions, among other examples.

In some aspects, a UE (e.g., UE 120) includes means for transmitting capability information regarding at least one of a multicast PDSCH communication for an inactive mode or a multicast PDCCH communication for the inactive mode; means for receiving a configuration associated with the multicast PDCCH communication; means for receiving the multicast PDCCH communication in accordance with the configuration; and/or means for receiving the multicast PDSCH communication in the inactive mode based at least in part on the multicast PDCCH communication, wherein at least one of the configuration, or the multicast PDSCH communication is based at least in part on the capability information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for outputting a multicast PDCCH communication for a UE in accordance with a configuration associated with the multicast PDCCH communication; and/or means for outputting a multicast PDSCH communication for the UE in the inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more Cus, one or more Dus, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more Cus, one or more Dus, or one or more RUs). In some examples, a CU may be implemented within a network node, and one or more Dus may be co-located with the CU, or alternatively, may be geographically or virtually distributed throughout one or multiple other network nodes. The Dus may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more Dus 330 via respective midhaul links, such as through F1 interfaces. Each of the Dus 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the Cus 310, the Dus 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, Cus 310, Dus 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more Cus 310, one or more Dus 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

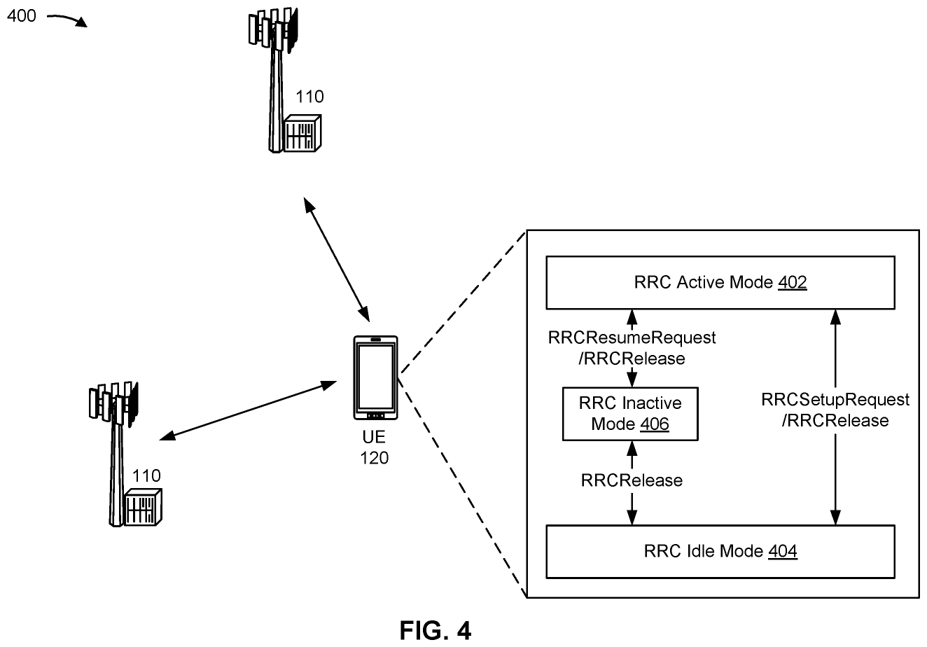

FIG. 4 illustrates an example 400 of a wireless network (e.g., wireless network 100) in which a UE (e.g., a UE 120) may support communication modes, in accordance with the present disclosure. The UE may be communicatively connected with one or more network nodes 110 in the wireless network. For example, the UE may be connected to the one or more network nodes 110 in a dual connectivity configuration. In this case, a first network node 110 may serve the UE as a master node and a second network node 110 may serve the UE as a secondary node. The techniques described herein can also be implemented for a UE connected to a single network node 110.

As illustrated in FIG. 4, the UE may support a connected mode (e.g., an RRC active mode 402), an idle mode (e.g., an RRC idle mode 404), and an inactive mode (e.g., an RRC inactive mode 406). RRC inactive mode 406 may functionally reside between RRC active mode 402 and RRC idle mode 404.

The UE may transition between different modes based at least in part on various commands and/or communications received from the one or more network nodes 110. For example, the UE may transition from RRC active mode 402 or RRC inactive mode 406 to RRC idle mode 404 based at least in part on receiving an RRCRelease communication. As another example, the UE may transition from RRC active mode 402 to RRC inactive mode 406 based at least in part on receiving an RRCRelease with suspendConfig communication. As another example, the UE may transition from RRC idle mode 404 to RRC active mode 402 based at least in part on receiving an RRCSetupRequest communication. As another example, the UE may transition from RRC inactive mode 406 to RRC active mode 402 based at least in part on receiving an RRCResumeRequest communication.

When transitioning to RRC inactive mode 406, the UE and/or the one or more network nodes 110 may store a UE context (e.g., an access stratum (AS) context and/or higher-layer configurations). This permits the UE and/or the one or more network nodes 110 to apply the stored UE context when the UE transitions from RRC inactive mode 406 to RRC active mode 402 in order to resume communications with the one or more network nodes 110, which reduces latency of transitioning to RRC active mode 402 relative to transitioning to the RRC active mode 402 from RRC idle mode 404.

In some cases, the UE may communicatively connect with a new master node when transitioning from RRC idle mode 404 or RRC inactive mode 406 to RRC active mode 402 (e.g., a master node that is different from the last serving master node when the UE transitioned to RRC idle mode 404 or RRC inactive mode 406). In this case, the new master node may be responsible for identifying a secondary node for the UE in the dual connectivity configuration.

Some UEs may support reception of multicast communications in the RRC inactive mode 406. Some techniques described herein provide signaling, rules, and configurations for receiving multicast communications in the RRC inactive mode 406.

As indicated above, FIG. 4 is provided as an example. Other examples may differ from what is described with regard to FIG. 4.

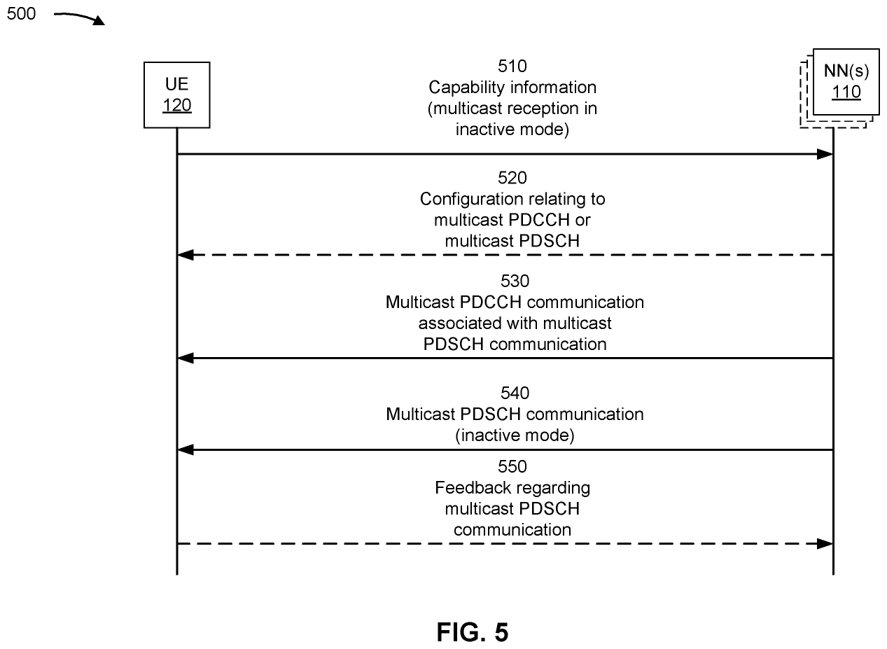

FIG. 5 is a diagram illustrating an example 500 of signaling associated with a multicast PDSCH communication in inactive mode, in accordance with the present disclosure. As shown, example 500 includes a UE 120 and a network node 110. While example 500 relates to a multicast PDSCH transmission to the UE 120 in inactive mode (e.g., RRC inactive mode 406), the UE 120 may be in a connected mode for some operations of example 500, such as (at least) capability information transmission and configuration of a multicast PDCCH and/or PDSCH. As shown, the network node 110 may include multiple network nodes. For example, the network node may include one or more of a CU, an RU, or a DU, as described with regard to FIG. 3. Actions described as being performed by the network node 110 may be performed by one or more network nodes of the network node 110, as defined by a functional split (also described with regard to FIG. 3).

As shown, the UE 120 may transmit capability information 510. The network node 110 may obtain the capability information 510. For example, the network node 110 may receive the capability information 510 from the UE 120. As another example, the network node 110 may receive the capability information 510 from another network node 110 (e.g., an RU). In some aspects, the capability information 510 may be referred to as UE capability information. The capability information 510 may relate to at least one of a multicast PDSCH communication 540 for an inactive mode, or a multicast PDCCH communication 530 associated with the multicast PDSCH communication 540. For example, the capability information 510 may indicate one or more capabilities associated with receiving a multicast PDCCH communication 530, one or more capabilities associated with receiving a multicast PDSCH communication 540, or a combination thereof. In some aspects, the capability information 510 may include information not relating to a multicast PDSCH communication 540 or a multicast PDCCH communication 530. For example, the UE 120 may transmit capability information including capability information 510 regarding at least one of the multicast PDCCH communication or the multicast PDSCH communication, as well as other capability information. Particular examples of capabilities indicated by the capability information 510 are provided below.

A multicast PDCCH communication 530 is a PDCCH communication carrying information (e.g., downlink control information (DCI)) relating to a multicast PDSCH communication 540. A PDCCH communication may be transmitted using a PDCCH. A multicast PDSCH communication 540 is a PTM transmission. A multicast PDSCH communication 540 is a PDSCH communication directed to multiple UEs 120, such as multiple UEs 120 associated with a group identifier (e.g., an RNTI, described elsewhere herein). A multicast PDSCH communication 540 may be transmitted via a PDSCH.

In some aspects, the capability information 510 may indicate a capability relating to a control resource set (CORESET) for an inactive mode. Control information (e.g., a multicast PDCCH communication) may be transmitted in a CORESET. For example, DCI may be mapped on a PDCCH. The PDCCH may occupy a number of resource elements (REs) according to an aggregation level. The PDCCH may be mapped onto a search space set according to the content of the DCI. The search space set may be mapped onto a CORESET. The CORESET may define a set of resource blocks (RBs) and symbols available to the search space set, as well as other physical layer characteristics of the search space set and/or the PDCCH. Thus, the UE 120 may monitor resources indicated by the CORESET for a multicast PDCCH communication 530 mapped to the search space set. One or multiple CORESETs for a multicast PDCCH may be configured in a multicast common frequency resource (CFR). In some aspects, the capability relating to the CORESET for the inactive mode may indicate a number of CORESETs that the UE 120 is capable of monitoring in the inactive state. For example, the capability may indicate a maximum number of CORESETs that the UE 120 is capable of monitoring in the inactive state. In some aspects, the maximum number of CORESETs configured for unicast/multicast per DL BWP in connected mode may be larger than that of CORESETs configured for multicast/broadcast signals in inactive mode.

In some aspects, the capability information 510 may indicate a capability relating to multiplexing of the multicast PDSCH communication 540 for an inactive mode. The multiplexing may include, for example, inter-slot time division multiplexing (TDM), in which the multicast PDSCH communication 540 is multiplexed, in the time domain, with another PDSCH across multiple slots, or intra-slot TDM, in which the multicast PDSCH communication 540 is multiplexed in the time domain with another PDSCH in a given slot. In some aspects, the capability may indicate whether the UE 120 supports intra-slot TDM of the multicast PDSCH communication 540 with another multicast PDSCH communication or a broadcast PDSCH communication.

In some aspects, the capability information 510 may indicate a number of MIMO layers associated with the multicast PDSCH communication 540 in the inactive mode. Additionally, or alternatively, the capability information 510 may indicate a modulation scheme for the multicast PDSCH communication 540 in the inactive mode. For example, the capability information 510 may indicate a maximum number of MIMO layers supportable by the UE 120 in the inactive mode. As another example, the capability information 510 may indicate a maximum modulation scheme (e.g., a specific modulation scheme, a modulation and coding scheme index associated with the maximum modulation scheme) supportable by the UE 120 in the inactive mode. In some aspects, the capability information 510 may indicate a maximum number of MIMO layers and/or a maximum modulation scheme for multicast PDSCH communications in a connected mode. In such examples, the network node 110 may configure the multicast PDSCH communication 540 for the inactive mode, in accordance with the maximum number of MIMO layers and/or the maximum modulation scheme for multicast PDSCH communications in the connected mode. For example, the maximum number of MIMO layers and/or the maximum modulation scheme for multicast PDSCH communications in the inactive mode may be no larger than the maximum number of MIMO layers and/or the maximum modulation scheme for multicast PDSCH communications in the connected mode. In some aspects, only single-layer transmission is supported for multicast in the inactive mode.

In some aspects, the capability information 510 may indicate a capability associated with RB symbol level rate matching for the inactive mode. “RB symbol level rate matching” refers to rate matching a communication around an RB (in frequency) and a symbol (in time). “Rate matching” refers to changing the code rate of a channel (e.g., a PDSCH) such that the same amount of data is conveyed via the channel after a portion of the channel (e.g., one or more RBs and/or one or more symbols) is used for a purpose other than conveying the data. RB symbol level rate matching may be defined by a set of parameters rateMatchPatternToAddModList, rateMatchPatternGroup1 and rateMatchPatternGroup2, which can be configured in PDSCH-Config-Multicast for rate matching of a multicast PDSCH communication 540. In some aspects, the capability information 510 may indicate whether the UE 120 supports RB symbol level rate matching for the multicast PDSCH communication 540 in the inactive mode. In some aspects, the capability information 510 may indicate whether the UE supports RB symbol level rate matching for multicast PDSCH communications in a connected mode. In such examples, the network node 110 may configure and/or transmit the multicast PDSCH communication 540 for the inactive mode, in accordance with the capability for RB symbol level rate matching in the connected mode.

In some aspects, the capability information 510 may indicate a capability associated with RE level rate matching for the inactive mode. “RE level rate matching” refers to rate matching a communication around one or more REs of the communication. RE level rate matching may be defined by a set of parameters p/sp-ZP-CSI-RS-ResourceSet which can be configured in PDSCH-Config-Multicast for rate matching of a multicast PDSCH communication. In some aspects, the capability information 510 may indicate whether the UE 120 supports RE level rate matching for the multicast PDSCH communication 540 in the inactive mode. In some aspects, the capability information 510 may indicate whether the UE supports RE level rate matching for multicast PDSCH communications in a connected mode. In such examples, the network node 110 may configure the multicast PDSCH communication 540 for the inactive mode, in accordance with the capability for RE level rate matching in the connected mode.

In some aspects, the capability information 510 may indicate a capability associated with an RNTI, such as a group radio network temporary identifier (G-RNTI) or a group configured scheduling RNTI (G-CS-RNTI). A G-CS-RNTI is an RNTI associated with SPS communication. For example, a UE 120 may support a maximum number of RNTIs. A multicast PDSCH communication may be directed to an RNTI, such as a G-RNTI or a G-CS-RNTI. A larger maximum number of RNTIs may provide increased flexibility for multicast PDSCH communications, whereas a smaller maximum number of RNTIs may be simpler to implement at the UE 120 and may have lower impact on the UE 120's RNTI budget. In some aspects, the capability information 510 may indicate a maximum number of RNTIs for the inactive mode. For example, the maximum number of RNTIs for the inactive mode may be lesser than a maximum number of RNTIs for a connected mode. In some aspects, the capability information 510 may indicate a maximum number of RNTIs for a connected mode. In such examples, the network node 110 may configure the maximum number of RNTIs, or may select an RNTI, for the multicast PDSCH communication 540 in the inactive mode in accordance with the maximum number of RNTIs for the connected mode.

In some aspects, the capability information 510 may indicate a capability associated with slot-level repetition in the inactive mode. “Slot-level repetition” refers to transmitting multiple transmissions of the multicast PDSCH communication 540 in multiple slots such that the UE 120 can combine the multiple transmissions, thereby improving reliability. In some aspects, the capability information 510 may indicate whether the UE 120 supports slot-level repetition for the inactive mode. In some aspects, the capability information 510 may indicate whether the UE 120 supports slot-level repetition for a connected mode. In such examples, the network node 110 may activate or deactivate slot-level repetition for the multicast PDSCH communication 540 in the inactive mode in accordance with the capability information 510 regarding slot-level repetition for the connected mode.

In some aspects, the capability information 510 may indicate whether the UE 120 supports scheduling of the multicast PDSCH communication 540 on a secondary cell (SCell), such as an SCell of a carrier aggregation configuration or a dual connectivity configuration.

In some aspects, the capability information 510 may indicate whether the UE 120 supports SPS configuration of the multicast PDSCH communication 540 for reception of the multicast PDSCH communication 540 in the inactive mode. For example, the capability information 510 may indicate whether the UE 120 supports configuration of an SPS configuration and reception of the multicast PDSCH communication 540 using the SPS configuration. As another example, the capability information 510 may indicate that the UE supports SPS multicast PDSCH communication without hybrid automatic repeat request (HARD) feedback.

As shown, the network node 110 may output, and the UE 120 may receive, a configuration 520 associated with a multicast PDCCH communication 530. For example, the configuration 520 may include one or more parameters of the multicast PDCCH communication 530, such as a CORESET (e.g., provided in a PDCCH-Config-Multicast information element (IE)), a search space set (e.g., provided in a SearchSpaceMulticast IE of the PDCCH-Config-Multicast IE), a multicast DCI format (e.g., DCI Format 4_1 or DCI Format 4_2, indicated in the SearchSpaceMulticast IE), or the like. In some aspects, the UE 120 may receive the configuration 520 (and/or one or more parameters relating to the multicast PDSCH communication) via unicast RRC signaling, such as while the UE 120 is in a connected mode.

In some aspects, the configuration 520, or another configuration received by the UE 120, may include one or more parameters of the multicast PDSCH communication 540. For example, the one or more parameters may indicate whether multiplexing is enabled for the multicast PDSCH communication 540 in the inactive mode. As another example, the one or more parameters may relate to rate matching of the multicast PDSCH communication 540 in the inactive mode.

In some aspects, the configuration 520 indicates a configuration of a CORESET configured in a multicast common frequency resource (CFR). A multicast CFR is a resource, configured in a downlink dedicated bandwidth part via unicast RRC signaling, and designated for multicast communication. In some aspects, the configuration 520 indicates a configuration of one or more multicast CORESETs in the multicast CFR. In some aspects, a multicast CORESET is a CORESET in which a multicast PDCCH communication can be received. In some aspects, a multicast CORESET is a CORESET configured in a multicast CFR.

In some aspects, the configuration 520 indicates a common search space set for multicast on a primary cell (PCell). For example, the configuration may indicate a Type 3 common search space set (CSS). A common search space set for multicast is a search space set to which DCI associated with a multicast PDSCH communication 540 is mapped.

As shown, the network node 110 may output, and the UE 120 may receive, the multicast PDCCH communication 530 in accordance with the configuration 520. For example, the UE 120 may monitor one or more CORESETs to receive the multicast PDCCH communication 530, such as one or more CORESETs configured by the configuration 520. In some aspects, the UE 120 may monitor multiple CORESETs in the inactive mode. For example, the UE 120 may monitor, in the inactive mode, two or more CORESETs, including a CORESET in a multicast CFR, a CORESET0 (which is a CORESET associated with system information block (SIB) transmission, paging, and broadcast), and at least one other CORESET. The at least one other CORESET may include, for example a CORESET configured in SIB1, or a CORESET for broadcast configured by a CFR-ConfigMCCH-MTCH IE if the CORESET is not configured in SIB1. In some aspects, the UE 120 may select a CORESET for monitoring. For example, if the UE supports monitoring of at most X CORESETs, and if a number of CORESETs for multicast in a connected state is larger than (X-2), then the UE 120 may select one or more CORESETs for monitoring in the inactive state such that X is not violated. For example, the UE 120 may select one or more CORESETs with a lowest CORESET identifier, among other examples. In some aspects, the capability information 510 may indicate X. Thus, the UE 120 may monitoring the CORESET in the multicast CFR, the CORESET zero, and at least one other CORESET in the inactive mode. In some aspects, monitoring the CORESET in the multicast CFR is based at least in part on the capability information 510. For example, the UE 120 may monitor at most X CORESETs, if the capability information 510 indicates X. The UE 120 may monitor one or more CSSs, such as a CSS for multicast on a PCell (e.g., the Type3 CSS described above).

The multicast PDCCH communication 530 may carry DCI. In some aspects, the configuration 520 may indicate a format of the DCI (such as in a configuration of a corresponding search space). In some aspects, the format of the DCI may be a format for scheduling multicast PDSCH communications (referred to as DCI Format 4_1, as specified by a 3GPP wireless communication specification), and for DCI having a format for scheduling PDSCH communications and associated with a group RNTI (referred to as DCI Format 4_2, as specified by a 3GPP wireless communication). For example, the DCI Format 4_2 may carry a G-RNTI or a G-CS-RNTI associated with the multicast PDSCH communication 540. In some aspects, the format of the DCI may be a format for scheduling a broadcast communication in a PCell (e.g., DCI format 4_0), with a group RNTI indicating that the DCI is associated with scheduling the multicast PDSCH communication 540. The UE 120 may monitor for the DCI. For example, the UE 120 may monitor for only DCI Format 4_1. As another example, the UE 120 may monitor for DCI Format 4_1 and DCI Format 4_2. As yet another example, the UE 120 may monitor for DCI Format 4_0 including the group RNTI.

As shown, the network node 110 may output, and the UE 120 may receive, a multicast PDSCH communication 540 in the inactive mode based at least in part on the multicast PDCCH communication 530. For example, the UE 120 may receive the multicast PDSCH communication 540 in the inactive mode, in a resource scheduled by the multicast PDCCH communication 530. In some aspects, the multicast PDCCH communication 530 may active an SPS configuration, and the UE 120 may receive the multicast PDSCH communication 540 in a resource indicated by the SPS configuration.

In some aspects, the multicast PDSCH communication 540 may be multiplexed with another PDSCH, such as another multicast PDSCH communication, a broadcast PDSCH communication, or another form of PDSCH communication. The UE 120 may not be required to support frequency division multiplexed multicast PDSCH communications 540 in the inactive mode. For example, the multicast PDSCH communication 540 may not be allowed to be frequency division multiplexed with another PDSCH. In some aspects, the multicast PDSCH communication 540 may be time division multiplexed with another PDSCH. For example, the UE 120 may support inter-slot TDM of the multicast PDSCH communication 540 and another PUSCH (e.g., the multicast PDSCH communication 540 may be inter-slot time division multiplexed with the other PUSCH). In some aspects, the UE 120 may support intra-slot time division multiplexing of multicast PDSCHs and/or broadcast PDSCHs, subject to the capability information 510, as described above. For example, if the capability information 510 indicates that the multicast PDSCH communication 540 can be intra-slot time division multiplexed with another PDSCH, then the multicast PDSCH communication 540 may be intra-slot time division multiplexed with the other PDSCH. In some aspects, intra-slot time division multiplexing of a unicast PDSCH communication within a slot is not permitted.

In some aspects, the multicast PDSCH communication 540 may have a number of MIMO layers and a modulation order. The number of MIMO layers may satisfy a maximum number of MIMO layers indicated by the capability information 510, as described above. The modulation order may satisfy a maximum modulation order indicated by the capability information 510, as described above. In some aspects, the maximum number of MIMO layers and/or the maximum modulation order may be no larger than that of a multicast PDSCH communication for the connected mode.

In some aspects, the multicast PDSCH communication 540 may be rate matched. For example, if the capability information 510 indicates that the UE 120 supports RB symbol level rate matching for the multicast PDSCH communication 540, then the multicast PDSCH communication 540 may be RB symbol level rate matched. As another example, if the capability information 510 indicates that the UE 120 supports RE level rate matching for the multicast PDSCH communication 540, then the multicast PDSCH communication 540 may be RE level rate matched. As mentioned above, in some aspects, the capability information 510 may indicate a capability of the UE 120 supports rate matching (e.g., RE level rate matching and/or RB symbol level rate matching) for a connected mode, and the network node 110 may follow this capability for the inactive mode.

The multicast PDSCH communication 540 may be associated with an RNTI, such as a G-RNTI or a G-CS-RNTI. The RNTI may be selected from a number of multicast RNTIs, which may have a maximum quantity equal to a maximum quantity for a connected mode or different than the maximum quantity for the connected mode.

In some aspects, the UE 120 may support PTM and PTP retransmission of the multicast PDSCH communication 540 in the connected mode, and may not support any retransmission in the inactive mode. In such examples, the UE may ignore a DCI field relating to retransmission, such as a new data indicator. In some aspects, the UE 120 may support retransmission of the multicast PDSCH communication 540 with a restriction in the inactive mode. For example, the UE 120 may support PTM retransmission of the multicast PDSCH communication 540 (that is, as another multicast PDSCH communication or a broadcast PDSCH communication) in the inactive mode. In some aspects, the UE 120 may not support PTP retransmission of the multicast PDSCH communication 540 in the inactive mode (that is, as a unicast PDSCH communication). In some aspects, the UE 120 may not support PTP retransmission or PTM retransmission of the multicast PDSCH communication 540 in the inactive mode.

In some aspects, the multicast PDSCH communication 540 may be associated with slot-level repetition, such as semi-static slot-level repetition (which may be configured via RRC signaling) or dynamic slot-level repetition (which may be indicated dynamically, such as by the multicast PDCCH communication 530). “Slot-level repetition” refers to repeatedly transmitting the multicast PDSCH communication 540, which enables combining of the multicast PDSCH communication 540 to improve coverage and reliability. In some aspects, the multicast PDSCH communication 540 may support slot level-repetition if slot-level repetition of multicast PDSCH communications is supported in the connected mode. In some aspects, the UE 120 may support one of semi-static slot-level repetition or dynamic slot-level repetition, and not the other of semi-static slot-level repetition or dynamic slot-level repetition.

In some aspects, the multicast PDSCH communication 540 may be associated with an SPS configuration. For example, the UE 120 may support SPS configuration of resources for a multicast PDSCH communication 540 in the connected mode, and may not support SPS multicast PDSCH communication in the inactive mode. In such examples, the UE 120 may not be configured with SPS multicast PDSCH transmission. In some aspects, the UE 120 may be configured with SPS multicast PDSCH transmission in the connected mode, and may ignore the SPS multicast configurations in the inactive mode. In some aspects, the UE 120 may support SPS configuration for the multicast PDSCH communication 540 with a restriction in the inactive mode. In some aspects, the UE 120 may support SPS configuration of resources for a multicast PDSCH communication 540 without feedback (e.g., with HARQ feedback disabled). For example, the UE 120 may support SPS configuration of resources for a multicast PDSCH communication 540 without feedback if indicated by the UE 120's capability information 510. For example, after an SPS configuration (which may be configured, for example, by the configuration 520) is activated in a connected mode, the UE 120 may transit to an inactive mode, and may continue to receive multicast PDSCH communications in accordance with the SPS configuration without receiving separate PDCCHs for the multicast PDSCH communications and without providing HARQ feedback. However, the UE 120 may not transmit an acknowledgement for an SPS release of the SPS configuration. Alternatively, the UE 120 may stop receiving SPS multicast PDSCH based at least in part on a timer configured for the inactive mode. If the timer expired after the UE transitions into the inactive mode, the UE 120 may not receive the SPS multicast PDSCH, even without SPS release of the SPS configuration. In some aspects, the UE 120 may not support SPS configuration for the multicast PDSCH communication 540 in the inactive mode. For example, the UE 120 may not support receiving a multicast PDSCH communication 540 on a resource of an SPS configuration while in an inactive mode. In such examples, the UE 120 may ignore a configuration of an SPS configuration (e.g., for a multicast PDSCH communication) that is received while the UE 120 is in a connected mode, or may not expect to receive such a configuration.

In some aspects, the multicast PDSCH communication 540 may be received on an SCell. An SCell is a cell used for data communication, whereas a PCell is used for data communication and control signaling. SCells can be activated and deactivated via dynamic signaling on the PCell. In some aspects, the UE 120 may support reception of multicast PDSCH communications 540 on an SCell. For example, the capability information 510 may indicate whether the UE 120 supports reception of multicast PDSCH communications 540 on an SCell. In some aspects, the UE 120 may support reception of multicast PDSCH communications 540 on an SCell in the connected mode, and may not support reception of multicast PCSCH communication 540 in the inactive mode. For example, the UE 120 and/or the network node 110 may reconfigure an SCell to be a PCell (e.g., in RRC release message) when the SCell is to be used to receive a multicast PDSCH communication 540 while in an inactive mode (thereby preserving the scheduled multicast PDSCH communication 540). As another example, the UE 120 may, upon transitioning to an inactive mode, stop receiving multicast PDSCH communications in SCells of the UE 120. In some aspects, the UE 120 may support reception of multicast PDSCH communications 540 on an SCell in the inactive mode, same as that of the connected mode.

In some aspects, the multicast PDSCH communication 540 may be received on a non-serving cell of the UE 120.

As shown, in some aspects, the UE 120 may transmit, and the network node 110 may obtain (e.g., receive from the UE 120 or receive from another network node 110), feedback 550 regarding the multicast PDSCH communication 540. For example, the UE 120 may transmit feedback 550 (e.g., HARQ acknowledgment (HARQ-ACK) feedback) indicating whether the multicast PDSCH communication 540 was received. In some aspects, the feedback 550 may be negative ACK (NACK) only feedback. For example, the UE 120 may transmit a NACK only if a multicast PDSCH communication is not received. In some aspects, the NACK-only feedback may pertain to a group of transport blocks (TBs), which reduces a number of uplink transmissions relative to providing separate feedback for all TBs. In some aspects, the capability information 510 may indicate whether the UE 120 supports NACK-only feedback.

In some aspects, the UE 120 may transition to a connected mode to transmit the feedback 550. For example, the UE 120 may perform a UE-initiated transition to the connected mode to improve reliability of transmission of the feedback 550. In some aspects, the UE 120 may transition to the connected mode to transmit the feedback 550 based at least in part on a threshold, such as a threshold number of failed receptions of TBs.

In some aspects, the UE 120 may not support feedback regarding the multicast PDSCH communication 540 in the inactive mode. In the connected mode, the HARQ-ACK feedback can be enabled/disabled for a G-RNTI by RRC signaling or multicast DCI associated with the G-RNTI. For example, the UE 120 may not expect to be configured with enabled HARQ-ACK feedback (e.g., per G-RNTI). As another example, the UE 120 may ignore a HARQ-ACK feedback configuration in the inactive mode if the HARQ-ACK feedback configuration is enabled for the connected mode (e.g., in the connected mode) (e.g., per G-RNTI).

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with downlink multicast reception for an inactive mode UE.

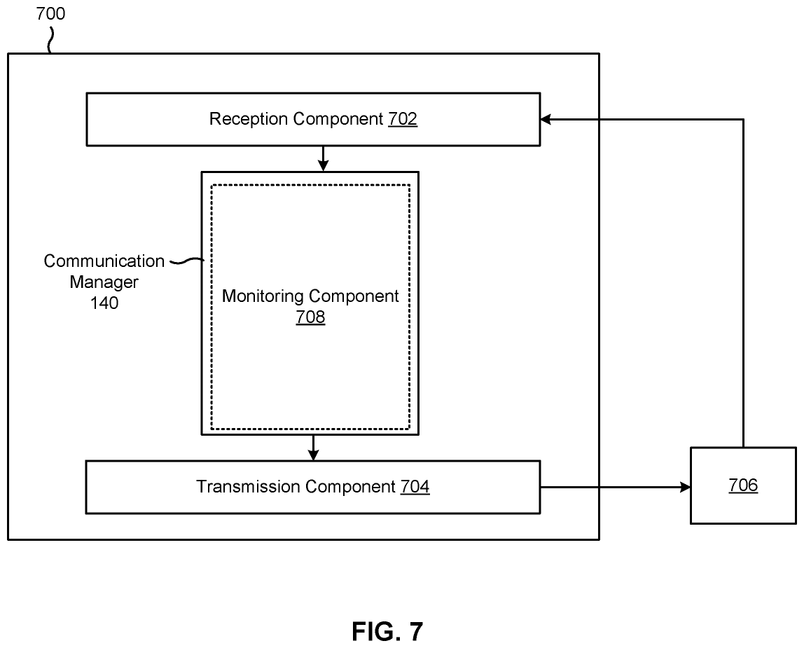

As shown in FIG. 6, in some aspects, process 600 may include transmitting capability information regarding at least one of a multicast PDSCH communication for an inactive mode or a multicast PDCCH communication for the inactive mode (block 610). For example, the UE (e.g., using communication manager 140 and/or transmission component 704, depicted in FIG. 7) may transmit capability information regarding at least one of a multicast PDSCH communication for an inactive mode or a multicast PDCCH communication for the inactive mode, as described above.

As further shown in FIG. 6, in some aspects, process 600 may include receiving a configuration associated with the multicast PDCCH communication (block 620). For example, the UE (e.g., using communication manager 140 and/or reception component 702, depicted in FIG. 7) may receive a configuration associated with the multicast PDCCH communication, as described above.

As further shown in FIG. 6, in some aspects, process 600 may include receiving the multicast PDCCH communication in accordance with the configuration (block 630). For example, the UE (e.g., using communication manager 140 and/or reception component 702, depicted in FIG. 7) may receive the multicast PDCCH communication in accordance with the configuration, as described above.

As further shown in FIG. 6, in some aspects, process 600 may include receiving the multicast PDSCH communication in the inactive mode based at least in part on the multicast PDCCH communication, wherein at least one of the configuration, or the multicast PDSCH communication is based at least in part on the capability information (block 640). For example, the UE (e.g., using communication manager 140 and/or reception component 702, depicted in FIG. 7) may receive the multicast PDSCH communication in the inactive mode based at least in part on the multicast PDCCH communication, wherein at least one of the configuration, or the multicast PDSCH communication is based at least in part on the capability information, as described above.

Process 600 may include additional aspects, such as any single aspect or any combination of aspects described below and/or in connection with one or more other processes described elsewhere herein.

In a first aspect, the configuration associated with the multicast PDCCH communication indicates a configuration of a CORESET configured in a multicast CFR, and wherein the method further comprises monitoring, in the inactive mode, the CORESET in the multicast CFR and at least one CORESET selected from a CORESET zero for system information, paging, or broadcast, or a CORESET configured by a system information block 1 (SIB1), or a CORESET configured for broadcast.

In a second aspect, alone or in combination with the first aspect, monitoring the CORESET in the multicast CFR further comprises monitoring the CORESET in the multicast CFR, the CORESET zero, and at least one other CORESET in the inactive mode.

In a third aspect, alone or in combination with one or more of the first and second aspects, monitoring the CORESET in the multicast CFR is based at least in part on the capability information.

In a fourth aspect, alone or in combination with one or more of the first through third aspects, the configuration indicates a common search space set for multicast on a PCell, and wherein receiving the multicast PDCCH communication in the inactive mode further comprises monitoring the common search space for the multicast PDCCH communication.

In a fifth aspect, alone or in combination with one or more of the first through fourth aspects, receiving the multicast PDCCH communication further comprises monitoring for DCI having a format for scheduling multicast PDSCH communications.

In a sixth aspect, alone or in combination with one or more of the first through fifth aspects, receiving the multicast PDCCH communication further comprises monitoring for DCI having a format for scheduling multicast PDSCH communications, and for DCI having a format for scheduling PDSCH communications and associated with a group radio network temporary identifier.

In a seventh aspect, alone or in combination with one or more of the first through sixth aspects, receiving the multicast PDCCH communication further comprises monitoring for DCI having a format for scheduling broadcast PDSCH communications and associated with a group radio network temporary identifier.

In an eighth aspect, alone or in combination with one or more of the first through seventh aspects, the UE is not required to support frequency division multiplexing of the multicast PDSCH communication and another PDSCH communication.

In a ninth aspect, alone or in combination with one or more of the first through eighth aspects, the multicast PDSCH communication is time division multiplexed with another PDSCH communication across multiple slots.

The method of claim 1, wherein, based at least in part on the capability information, the multicast PDSCH communication is time division multiplexed with another multicast PDSCH communication or a broadcast PDSCH communication within a slot.

In a tenth aspect, alone or in combination with one or more of the first through ninth aspects, the multicast PDSCH communication is not permitted to be time division multiplexed with a unicast PDSCH communication within the slot.

In an eleventh aspect, alone or in combination with one or more of the first through tenth aspects, the capability information indicates a number of MIMO layers for the multicast PDSCH communication or a modulation scheme for the multicast PDSCH communication for the inactive mode, and wherein the number of MIMO layers or the modulation scheme is less than or equal to a number of MIMO layers or a modulation scheme for a connected mode.

In a twelfth aspect, alone or in combination with one or more of the first through eleventh aspects, receiving the multicast PDSCH communication further comprises receiving the multicast PDSCH communication using resource block symbol level rate matching based at least in part on the capability information including information indicating that the UE supports resource block symbol level rate matching in a connected mode.

In a thirteenth aspect, alone or in combination with one or more of the first through twelfth aspects, receiving the multicast PDSCH communication further comprises receiving the multicast PDSCH communication using resource element level rate matching based at least in part on the capability information including information indicating that the UE supports resource element level rate matching in a connected mode.

In a fourteenth aspect, alone or in combination with one or more of the first through thirteenth aspects, the multicast PDCCH communication is associated with a G-RNTI selected from a group of G-RNTIs, and wherein a maximum quantity of G-RNTIs of the group of G-RNTIs is equal to a maximum quantity of G-RNTIs for a connected mode.

In a fifteenth aspect, alone or in combination with one or more of the first through fourteenth aspects, the multicast PDCCH communication is associated with a G-RNTI selected from a group of G-RNTIs, and wherein a maximum quantity of G-RNTIs, of the group of G-RNTIs, is different than a maximum quantity of G-RNTIs for a connected mode.

In a sixteenth aspect, alone or in combination with one or more of the first through fifteenth aspects, automatic repeat request is not supported for the multicast PDSCH communication based at least in part on the multicast PDSCH communication being associated with the inactive mode.

In a seventeenth aspect, alone or in combination with one or more of the first through sixteenth aspects, process 600 includes transmitting NACK-only feedback regarding the multicast PDSCH communication.

In an eighteenth aspect, alone or in combination with one or more of the first through seventeenth aspects, process 600 includes transmitting an indication to transition to a connected mode based at least in part on a number of failed resource block receptions, in the inactive mode, satisfying a threshold.

In a nineteenth aspect, alone or in combination with one or more of the first through eighteenth aspects, process 600 includes receiving a point-to-multipoint retransmission of the multicast PDSCH communication.

In a twentieth aspect, alone or in combination with one or more of the first through nineteenth aspects, the UE does not support point-to-point retransmission of the multicast PDSCH communication.

In a twenty-first aspect, alone or in combination with one or more of the first through twentieth aspects, the multicast PDSCH communication uses slot-level repetition based at least in part on the capability information indicating that the UE is capable of slot-level repetition for multicast PDSCH communications in a connected mode.

In a twenty-second aspect, alone or in combination with one or more of the first through twenty-first aspects, semi-persistent scheduling is not configurable for the multicast PDSCH communication.

In a twenty-third aspect, alone or in combination with one or more of the first through twenty-second aspects, the multicast PDSCH communication is associated with a semi-persistent scheduling configuration.

In a twenty-fourth aspect, alone or in combination with one or more of the first through twenty-third aspects, the multicast PDSCH communication can be scheduled only on a primary cell of the UE.

In a twenty-fifth aspect, alone or in combination with one or more of the first through twenty-fourth aspects, the capability information indicates whether the UE supports scheduling of the multicast PDSCH communication on a secondary cell.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include a monitoring component 708, among other examples.

In some aspects, the apparatus 700 may be configured to perform one or more operations described herein in connection with FIG. 5. Additionally, or alternatively, the apparatus 700 may be configured to perform one or more processes described herein, such as process 600 of FIG. 6, or a combination thereof. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The transmission component 704 may transmit capability information regarding at least one of a multicast PDSCH communication for an inactive mode or a multicast PDCCH communication for the inactive mode. The reception component 702 may receive a configuration associated with the multicast PDCCH communication. The reception component 702 or the monitoring component 708 may receive the multicast PDCCH communication in accordance with the configuration. The reception component 702 may receive the multicast PDSCH communication in the inactive mode based at least in part on the multicast PDCCH communication, wherein at least one of the configuration, or the multicast PDSCH communication is based at least in part on the capability information.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram illustrating an example process 800 performed, for example, by a network node, in accordance with the present disclosure. Example process 800 is an example where the network node (e.g., network node 110) performs operations associated with downlink multicast reception for inactive mode UEs.

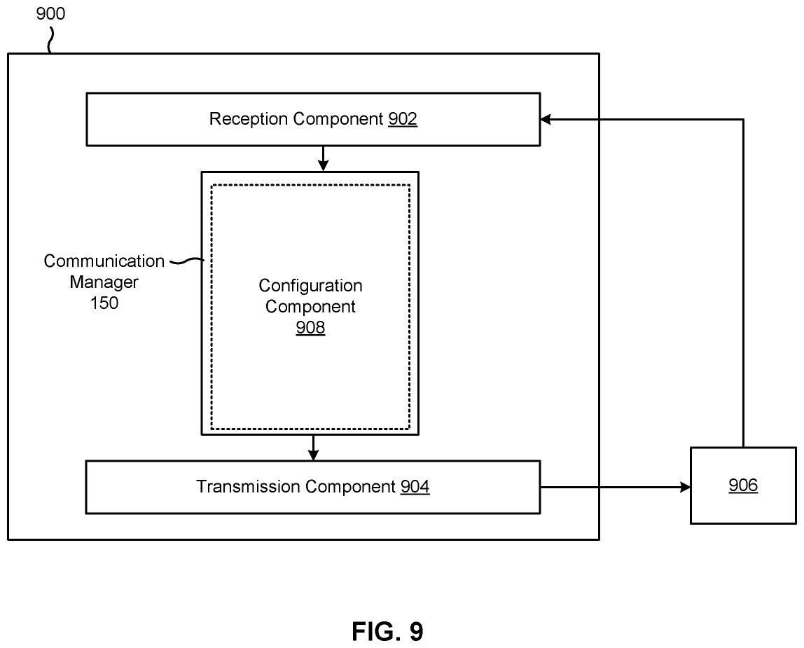

As shown in FIG. 8, in some aspects, process 800 may include outputting a multicast PDCCH communication for a UE in accordance with a configuration associated with the multicast PDCCH communication (block 810). For example, the network node (e.g., using communication manager 150 and/or transmission component 904, depicted in FIG. 9) may output a multicast PDCCH communication for a UE in accordance with a configuration associated with the multicast PDCCH communication, as described above. In some aspects, the network node may transmit the multicast PDCCH communication. In some aspects, the network node may provide the multicast PDCCH communication for transmission by another network node (e.g., an RU). In some aspects, the network node may configure another network node (e.g., a DU or an RU) to transmit the multicast PDCCH communication. The multicast PDCCH communication may be for the UE because the multicast PDCCH communication may be directed to the UE. In some aspects, the network node may output the configuration associated with the multicast PDCCH communication.

As further shown in FIG. 8, in some aspects, process 800 may include outputting a multicast PDSCH communication for the UE in the inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication (block 820). For example, the network node (e.g., using communication manager 150 and/or transmission component 904, depicted in FIG. 9) may output a multicast PDSCH communication for the UE in the inactive mode based at least in part on the multicast PDCCH communication At least one of the configuration, or the multicast PDSCH communication, may be based at least in part on capability information associated with the UE. The capability information may relate to at least one of the multicast PDSCH communication for an inactive mode or the multicast PDCCH communication, as described above. In some aspects, the network node may transmit the multicast PDSCH communication. In some aspects, the network node may provide the multicast PDSCH communication for transmission by another network node (e.g., an RU). In some aspects, the network node may configure another network node (e.g., a DU or an RU) to transmit the multicast PDSCH communication. The multicast PDSCH communication may be for the UE because the multicast PDSCH communication may be directed to the UE and/or transmitted on resources granted for the UE by the multicast PDCCH communication. In some aspects, the network node may obtain the capability information.

Process 800 may include additional aspects, such as any single aspect or any combination of aspects described below and/or in connection with one or more other processes described elsewhere herein.

In a first aspect, the configuration associated with the multicast PDCCH communication indicates a configuration of a control resource set (CORESET) configured in a multicast common frequency resource (CFR).

In a second aspect, alone or in combination with the first aspect, the CORESET in the multicast CFR is based at least in part on the capability information.

In a third aspect, alone or in combination with one or more of the first and second aspects, the configuration indicates a common search space set configured for multicast, and wherein outputting the multicast PDCCH communication further comprises outputting the multicast PDCCH communication in the common search space.

In a fourth aspect, alone or in combination with one or more of the first through third aspects, outputting the multicast PDCCH communication further comprises outputting downlink control information (DCI) having a format for scheduling multicast PDSCH communications.

In a fifth aspect, alone or in combination with one or more of the first through fourth aspects, outputting the multicast PDCCH communication further comprises outputting at least one of downlinking control information (DCI) having a format for scheduling multicast PDSCH communications, or DCI having a format for scheduling PDSCH communications and associated with a group radio network temporary identifier for multicast.

In a sixth aspect, alone or in combination with one or more of the first through fifth aspects, outputting the multicast PDCCH communication further comprises outputting downlink control information (DCI) having a format for scheduling broadcast PDSCH communications and associated with a group radio network temporary identifier for multicast.

In a seventh aspect, alone or in combination with one or more of the first through sixth aspects, the multicast PDSCH communication is time division multiplexed with another PDSCH communication across multiple slots.

The method of claim 29, wherein, based at least in part on the capability information, the multicast PDSCH communication is time division multiplexed with another multicast PDSCH communication or a broadcast PDSCH communication within a slot.

In an eighth aspect, alone or in combination with one or more of the first through seventh aspects, the multicast PDSCH communication is not permitted to be time division multiplexed with a unicast PDSCH communication within the slot.

In a ninth aspect, alone or in combination with one or more of the first through eighth aspects, the capability information indicates a number of multiple-input multiple-output (MIMO) layers for the multicast PDSCH communication or a modulation scheme for the multicast PDSCH communication for the inactive mode, and wherein the number of MIMO layers or the modulation scheme is less than or equal to a number of MIMO layers or a modulation scheme for a connected mode.

In a tenth aspect, alone or in combination with one or more of the first through ninth aspects, outputting the multicast PDSCH communication further comprises outputting the multicast PDSCH communication using resource block symbol level rate matching based at least in part on the capability information including information indicating that the UE supports resource block symbol level rate matching in a connected mode.

In an eleventh aspect, alone or in combination with one or more of the first through tenth aspects, outputting the multicast PDSCH communication further comprises outputting the multicast PDSCH communication using resource element level rate matching based at least in part on the capability information including information indicating that the UE supports resource element level rate matching in a connected mode.

In a twelfth aspect, alone or in combination with one or more of the first through eleventh aspects, the multicast PDCCH communication is associated with a group radio network temporary identifier (G-RNTI) selected from a group of G-RNTIs, and wherein a maximum quantity of G-RNTIs of the group of G-RNTIs is equal to a maximum quantity of G-RNTIs for a connected mode.

In a thirteenth aspect, alone or in combination with one or more of the first through twelfth aspects, the multicast PDCCH communication is associated with a group radio network temporary identifier (G-RNTI) selected from a group of G-RNTIs, and wherein a maximum quantity of G-RNTIs, of the group of G-RNTIs, is different than a maximum quantity of G-RNTIs for a connected mode.

In a fourteenth aspect, alone or in combination with one or more of the first through thirteenth aspects, automatic repeat request is not supported for the multicast PDSCH communication based at least in part on the multicast PDSCH communication being associated with the inactive mode.

In a fifteenth aspect, alone or in combination with one or more of the first through fourteenth aspects, process 800 includes obtaining negative acknowledgment (NACK)-only feedback regarding the multicast PDSCH communication.

In a sixteenth aspect, alone or in combination with one or more of the first through fifteenth aspects, process 800 includes obtaining an indication to transition to a connected mode based at least in part on a number of failed resource block receptions, in the inactive mode, satisfying a threshold.

In a seventeenth aspect, alone or in combination with one or more of the first through sixteenth aspects, process 800 includes outputting a point-to-multipoint retransmission of the multicast PDSCH communication.

In an eighteenth aspect, alone or in combination with one or more of the first through seventeenth aspects, the multicast PDSCH communication uses slot-level repetition based at least in part on the capability information indicating that the UE is capable of slot-level repetition for multicast PDSCH communications in a connected mode.

In a nineteenth aspect, alone or in combination with one or more of the first through eighteenth aspects, the multicast PDSCH communication is associated with a semi-persistent scheduling configuration.

In a twentieth aspect, alone or in combination with one or more of the first through nineteenth aspects, the multicast PDSCH communication can be scheduled only on a primary cell of the UE.

In a twenty-first aspect, alone or in combination with one or more of the first through twentieth aspects, the capability information indicates whether the UE supports scheduling of the multicast PDSCH communication on a secondary cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a configuration component 908, among other examples.

In some aspects, the apparatus 900 may be configured to perform one or more operations described herein in connection with FIGS. 4-5. Additionally, or alternatively, the apparatus 900 may be configured to perform one or more processes described herein, such as process 800 of FIG. 8, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The transmission component 904 may output a multicast physical downlink control channel (PDCCH) communication for a UE in accordance with a configuration associated with the multicast PDCCH communication. The transmission component 904 may output a multicast PDSCH communication for the UE in the inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication.

The reception component 902 may obtain negative acknowledgment (NACK)-only feedback regarding the multicast PDSCH communication.

The reception component 902 may obtain an indication to transition to a connected mode based at least in part on a number of failed resource block receptions, in the inactive mode, satisfying a threshold.

The transmission component 904 may output a point-to-multipoint retransmission of the multicast PDSCH communication.

The configuration component 908 may generate and/or output the configuration.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting capability information regarding at least one of a multicast physical downlink shared channel (PDSCH) communication for an inactive mode or a multicast physical downlink control channel (PDCCH) communication for the inactive mode; receiving a configuration associated with the multicast PDCCH communication; receiving the multicast PDCCH communication in accordance with the configuration; and receiving the multicast PDSCH communication in the inactive mode based at least in part on the multicast PDCCH communication, wherein at least one of the configuration, or the multicast PDSCH communication is based at least in part on the capability information.

Aspect 2: The method of Aspect 1, wherein the configuration associated with the multicast PDCCH communication indicates a configuration of a control resource set (CORESET) configured in a multicast common frequency resource (CFR), and wherein the method further comprises: monitoring, in the inactive mode, the CORESET in the multicast CFR and at least one CORESET selected from: a CORESET zero for system information, paging, or broadcast, or a CORESET configured by a system information block 1 (SIB1), or a CORESET configured for broadcast.

Aspect 3: The method of Aspect 2, wherein monitoring the CORESET in the multicast CFR further comprises monitoring the CORESET in the multicast CFR, the CORESET zero, and at least one other CORESET in the inactive mode.

Aspect 4: The method of Aspect 2, wherein monitoring the CORESET in the multicast CFR is based at least in part on the capability information.

Aspect 5: The method of any of Aspects 1-4, wherein the configuration indicates a common search space set configured for multicast, and wherein receiving the multicast PDCCH communication in the inactive mode further comprises monitoring the common search space for the multicast PDCCH communication.

Aspect 6: The method of any of Aspects 1-5, wherein receiving the multicast PDCCH communication further comprises monitoring for downlink control information (DCI) having a format for scheduling multicast PDSCH communications.

Aspect 7: The method of any of Aspects 1-6, wherein receiving the multicast PDCCH communication further comprises monitoring for downlink control information (DCI) having a format for scheduling multicast PDSCH communications, and for DCI having a format for scheduling PDSCH communications and associated with a group radio network temporary identifier for multicast.

Aspect 8: The method of any of Aspects 1-7, wherein receiving the multicast PDCCH communication further comprises monitoring for downlink control information (DCI) having a format for scheduling broadcast PDSCH communications and associated with a group radio network temporary identifier for multicast.

Aspect 9: The method of any of Aspects 1-8, wherein the UE is not required to support frequency division multiplexing of the multicast PDSCH communication and another PDSCH communication.

Aspect 10: The method of any of Aspects 1-9, wherein the multicast PDSCH communication is time division multiplexed with another PDSCH communication across multiple slots.

Aspect 11: The method of any of Aspects 1-10, wherein, based at least in part on the capability information, the multicast PDSCH communication is time division multiplexed with another multicast PDSCH communication or a broadcast PDSCH communication within a slot.

Aspect 12: The method of Aspect 11, wherein the multicast PDSCH communication is not permitted to be time division multiplexed with a unicast PDSCH communication within the slot.

Aspect 13: The method of any of Aspects 1-12, wherein the capability information indicates a number of multiple-input multiple-output (MIMO) layers for the multicast PDSCH communication or a modulation scheme for the multicast PDSCH communication for the inactive mode, and wherein the number of MIMO layers or the modulation scheme is less than or equal to a number of MIMO layers or a modulation scheme for a connected mode.

Aspect 14: The method of any of Aspects 1-13, wherein receiving the multicast PDSCH communication further comprises receiving the multicast PDSCH communication using resource block symbol level rate matching based at least in part on the capability information including information indicating that the UE supports resource block symbol level rate matching in a connected mode.

Aspect 15: The method of any of Aspects 1-14, wherein receiving the multicast PDSCH communication further comprises receiving the multicast PDSCH communication using resource element level rate matching based at least in part on the capability information including information indicating that the UE supports resource element level rate matching in a connected mode.

Aspect 16: The method of any of Aspects 1-15, wherein the multicast PDCCH communication is associated with a group radio network temporary identifier (G-RNTI) selected from a group of G-RNTIs, and wherein a maximum quantity of G-RNTIs of the group of G-RNTIs is equal to a maximum quantity of G-RNTIs for a connected mode.

Aspect 17: The method of any of Aspects 1-15, wherein the multicast PDCCH communication is associated with a group radio network temporary identifier (G-RNTI) selected from a group of G-RNTIs, and wherein a maximum quantity of G-RNTIs, of the group of G-RNTIs, is different than a maximum quantity of G-RNTIs for a connected mode.

Aspect 18: The method of any of Aspects 1-17, wherein hybrid automatic repeat request is not supported for the multicast PDSCH communication based at least in part on the multicast PDSCH communication being associated with the inactive mode.

Aspect 19: The method of any of Aspects 1-17, further comprising transmitting negative acknowledgment (NACK)-only feedback regarding the multicast PDSCH communication.

Aspect 20: The method of any of Aspects 1-19, further comprising transmitting an indication to transition to a connected mode based at least in part on a number of failed resource block receptions, in the inactive mode, satisfying a threshold.

Aspect 21: The method of any of Aspects 1-20, wherein the UE does not support retransmission of the multicast PDSCH communication.

Aspect 22: The method of any of Aspects 1-20, further comprising receiving a point-to-multipoint retransmission of the multicast PDSCH communication.

Aspect 23: The method of Aspect 22, wherein the UE does not support point-to-point retransmission of the multicast PDSCH communication.

Aspect 24: The method of any of Aspects 1-23, wherein the multicast PDSCH communication uses slot-level repetition based at least in part on the capability information indicating that the UE is capable of slot-level repetition for multicast PDSCH communications in a connected mode.

Aspect 25: The method of any of Aspects 1-24, wherein the UE does not support semi-persistent scheduling for the multicast PDSCH communication.

Aspect 26: The method of any of Aspects 1-24, wherein the multicast PDSCH communication is associated with a semi-persistent scheduling configuration.

Aspect 27: The method of any of Aspects 1-26, wherein the multicast PDSCH communication can be scheduled only on a primary cell of the UE.

Aspect 28: The method of any of Aspects 1-26, wherein the capability information indicates whether the UE supports scheduling of the multicast PDSCH communication on a secondary cell.

Aspect 29: A method of wireless communication performed by a network node, comprising: outputting a multicast physical downlink control channel (PDCCH) communication for a user equipment (UE) in accordance with a configuration associated with the multicast PDCCH communication; and outputting a multicast PDSCH communication for the UE in the inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication.

Aspect 30: The method of Aspect 29, wherein the configuration associated with the multicast PDCCH communication indicates a configuration of a control resource set (CORESET) configured in a multicast common frequency resource (CFR).

Aspect 31: The method of Aspect 30, wherein the CORESET in the multicast CFR is based at least in part on the capability information.

Aspect 32: The method of any of Aspects 29-31, wherein the configuration indicates a common search space set configured for multicast, and wherein outputting the multicast PDCCH communication further comprises outputting the multicast PDCCH communication in the common search space.

Aspect 33: The method of any of Aspects 29-32, wherein outputting the multicast PDCCH communication further comprises outputting downlink control information (DCI) having a format for scheduling multicast PDSCH communications.

Aspect 34: The method of any of Aspects 29-33, wherein outputting the multicast PDCCH communication further comprises outputting at least one of: downlink control information (DCI) having a format for scheduling multicast PDSCH communications, or DCI having a format for scheduling PDSCH communications and associated with a group radio network temporary identifier for multicast.

Aspect 35: The method of any of Aspects 29-34, wherein outputting the multicast PDCCH communication further comprises outputting downlink control information (DCI) having a format for scheduling broadcast PDSCH communications and associated with a group radio network temporary identifier for multicast.

Aspect 36: The method of any of Aspects 29-35, wherein the multicast PDSCH communication is time division multiplexed with another PDSCH communication across multiple slots.

Aspect 37: The method of any of Aspects 29-36, wherein, based at least in part on the capability information, the multicast PDSCH communication is time division multiplexed with another multicast PDSCH communication or a broadcast PDSCH communication within a slot.

Aspect 38: The method of Aspect 37, wherein the multicast PDSCH communication is not permitted to be time division multiplexed with a unicast PDSCH communication within the slot.

Aspect 39: The method of any of Aspects 29-38, wherein the capability information indicates a number of multiple-input multiple-output (MIMO) layers for the multicast PDSCH communication or a modulation scheme for the multicast PDSCH communication for the inactive mode, and wherein the number of MIMO layers or the modulation scheme is less than or equal to a number of MIMO layers or a modulation scheme for a connected mode.

Aspect 40: The method of any of Aspects 29-39, wherein outputting the multicast PDSCH communication further comprises outputting the multicast PDSCH communication using resource block symbol level rate matching based at least in part on the capability information including information indicating that the UE supports resource block symbol level rate matching in a connected mode.

Aspect 41: The method of any of Aspects 29-40, wherein outputting the multicast PDSCH communication further comprises outputting the multicast PDSCH communication using resource element level rate matching based at least in part on the capability information including information indicating that the UE supports resource element level rate matching in a connected mode.

Aspect 42: The method of any of Aspects 29-41, wherein the multicast PDCCH communication is associated with a group radio network temporary identifier (G-RNTI) selected from a group of G-RNTIs, and wherein a maximum quantity of G-RNTIs of the group of G-RNTIs is equal to a maximum quantity of G-RNTIs for a connected mode.

Aspect 43: The method of any of Aspects 29-41, wherein the multicast PDCCH communication is associated with a group radio network temporary identifier (G-RNTI) selected from a group of G-RNTIs, and wherein a maximum quantity of G-RNTIs, of the group of G-RNTIs, is different than a maximum quantity of G-RNTIs for a connected mode.

Aspect 44: The method of any of Aspects 29-43, wherein hybrid automatic repeat request is not supported for the multicast PDSCH communication based at least in part on the multicast PDSCH communication being associated with the inactive mode.

Aspect 45: The method of any of Aspects 29-43, further comprising obtaining negative acknowledgment (NACK)-only feedback regarding the multicast PDSCH communication.

Aspect 46: The method of any of Aspects 29-45, further comprising obtaining an indication to transition to a connected mode based at least in part on a number of failed resource block receptions, in the inactive mode, satisfying a threshold.

Aspect 47: The method of any of Aspects 29-46, further comprising outputting a point-to-multipoint retransmission of the multicast PDSCH communication.

Aspect 48: The method of any of Aspects 29-47, wherein the multicast PDSCH communication uses slot-level repetition based at least in part on the capability information indicating that the UE is capable of slot-level repetition for multicast PDSCH communications in a connected mode.

Aspect 49: The method of any of Aspects 29-48, wherein the multicast PDSCH communication is associated with a semi-persistent scheduling configuration.

Aspect 50: The method of any of Aspects 29-49, wherein the multicast PDSCH communication can be scheduled only on a primary cell of the UE.

Aspect 51: The method of any of Aspects 29-50, wherein the capability information indicates whether the UE supports scheduling of the multicast PDSCH communication on a secondary cell.

Aspect 52: An apparatus for wireless communication at a device, comprising a processor; memory coupled with the processor; and instructions stored in the memory and executable by the processor to cause the apparatus to perform the method of one or more of Aspects 1-51.

Aspect 53: A device for wireless communication, comprising a memory and one or more processors coupled to the memory, the one or more processors configured to perform the method of one or more of Aspects 1-51.

Aspect 54: An apparatus for wireless communication, comprising at least one means for performing the method of one or more of Aspects 1-51.

Aspect 55: A non-transitory computer-readable medium storing code for wireless communication, the code comprising instructions executable by a processor to perform the method of one or more of Aspects 1-51.

Aspect 56: A non-transitory computer-readable medium storing a set of instructions for wireless communication, the set of instructions comprising one or more instructions that, when executed by one or more processors of a device, cause the device to perform the method of one or more of Aspects 1-51.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit capability information regarding at least one of a multicast physical downlink shared channel (PDSCH) communication for an inactive mode or a multicast physical downlink control channel (PDCCH) communication for the inactive mode;
receive a configuration associated with the multicast PDCCH communication;
receive the multicast PDCCH communication in accordance with the configuration; and
receive the multicast PDSCH communication in the inactive mode based at least in part on the multicast PDCCH communication, wherein at least one of the configuration, or the multicast PDSCH communication is based at least in part on the capability information.

2. The UE of claim 1, wherein the configuration associated with the multicast PDCCH communication indicates a configuration of a control resource set (CORESET) configured in a multicast common frequency resource (CFR), and wherein the one or more processors are configured to:
monitor, in the inactive mode, the CORESET in the multicast CFR and at least one CORESET selected from:
a CORESET zero for system information, paging, or broadcast, or
a CORESET configured by a system information block 1 (SIB1), or
a CORESET configured for broadcast.

3. The UE of claim 2, wherein the one or more processors, to monitor the CORESET in the multicast CFR, are configured to monitor the CORESET in the multicast CFR, the CORESET zero, and at least one other CORESET in the inactive mode.

4. The UE of claim 1, wherein the configuration indicates a common search space set configured for multicast, and wherein the one or more processors, to receive the multicast PDCCH communication in the inactive mode, are configured to monitor the common search space for the multicast PDCCH communication.

5. The UE of claim 1, wherein the one or more processors, to receive the multicast PDCCH communication, are configured to monitor for downlink control information (DCI) having a format for scheduling multicast PDSCH communications.

6. The UE of claim 1, wherein the one or more processors, to receive the multicast PDCCH communication, are configured to monitor for downlink control information (DCI) having a format for scheduling multicast PDSCH communications, and for DCI having a format for scheduling PDSCH communications and associated with a group radio network temporary identifier for multicast.

7. The UE of claim 1, wherein the one or more processors, to receive the multicast PDCCH communication, are configured to monitor for downlink control information (DCI) having a format for scheduling broadcast PDSCH communications and associated with a group radio network temporary identifier for multicast.

8. The UE of claim 1, wherein the UE is not required to support frequency division multiplexing of the multicast PDSCH communication and another PDSCH communication.

9. The UE of claim 1, wherein the multicast PDSCH communication is configured to be time division multiplexed with another PDSCH communication across multiple slots.

10. The UE of claim 1, wherein, based at least in part on the capability information, the multicast PDSCH communication can be time division multiplexed with another multicast PDSCH communication or a broadcast PDSCH communication within a slot.

11. The UE of claim 1, wherein the capability information indicates a number of multiple-input multiple-output (MIMO) layers for the multicast PDSCH communication or a modulation scheme for the multicast PDSCH communication for the inactive mode, and wherein the number of MIMO layers or the modulation scheme is less than or equal to a number of MIMO layers or a modulation scheme for a connected mode.

12. The UE of claim 1, wherein the one or more processors, to receive the multicast PDSCH communication, are configured to receive the multicast PDSCH communication using resource block symbol level rate matching based at least in part on the capability information including information indicating that the UE supports resource block symbol level rate matching in a connected mode.

13. The UE of claim 1, wherein the one or more processors, to receive the multicast PDSCH communication, are configured to receive the multicast PDSCH communication using resource element level rate matching based at least in part on the capability information including information indicating that the UE supports resource element level rate matching in a connected mode.

14. The UE of claim 1, wherein the multicast PDCCH communication is associated with a group radio network temporary identifier (G-RNTI) selected from a group of G-RNTIs, and wherein a maximum quantity of G-RNTIs of the group of G-RNTIs is equal to a maximum quantity of G-RNTIs for a connected mode.

15. The UE of claim 1, wherein the multicast PDCCH communication is associated with a group radio network temporary identifier (G-RNTI) selected from a group of G-RNTIs, and wherein a maximum quantity of G-RNTIs, of the group of G-RNTIs, is different than a maximum quantity of G-RNTIs for a connected mode.

16. The UE of claim 1, wherein the one or more processors are further configured to transmit negative acknowledgment (NACK)-only feedback regarding the multicast PDSCH communication.

17. The UE of claim 1, wherein the one or more processors are further configured to transmit an indication to transition to a connected mode based at least in part on a number of failed resource block receptions, in the inactive mode, satisfying a threshold.

18. The UE of claim 1, wherein the one or more processors are further configured to receive a point-to-multipoint retransmission of the multicast PDSCH communication.

19. The UE of claim 1, wherein the multicast PDSCH communication uses slot-level repetition based at least in part on the capability information indicating that the UE is capable of slot-level repetition for multicast PDSCH communications in a connected mode.

20. A network node for wireless communication, comprising:
a memory; and
one or more processors, coupled to the memory, configured to:
output a multicast physical downlink control channel (PDCCH) communication for a user equipment (UE) in accordance with a configuration associated with the multicast PDCCH communication; and
output a multicast physical downlink shared channel (PDSCH) communication for the UE in an inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication.

21. The network node of claim 20, wherein the configuration associated with the multicast PDCCH communication indicates a configuration of a control resource set (CORESET) configured in a multicast common frequency resource (CFR).

22. The network node of claim 20, wherein the configuration indicates a common search space set configured for multicast, and wherein the one or more processors, to output the multicast PDCCH communication, are configured to output the multicast PDCCH communication in the common search space.

23. The network node of claim 20, wherein the multicast PDSCH communication is configured to be time division multiplexed with another PDSCH communication across multiple slots.

24. The network node of claim 20, wherein, based at least in part on the capability information, the multicast PDSCH communication can be time division multiplexed with another multicast PDSCH communication or a broadcast PDSCH communication within a slot.

25. The network node of claim 20, wherein the capability information indicates a number of multiple-input multiple-output (MIMO) layers for the multicast PDSCH communication or a modulation scheme for the multicast PDSCH communication for the inactive mode, and wherein the number of MIMO layers or the modulation scheme is less than or equal to a number of MIMO layers or a modulation scheme for a connected mode.

26. A method of wireless communication performed by a user equipment (UE), comprising:
transmitting capability information regarding at least one of a multicast physical downlink shared channel (PDSCH) communication for an inactive mode or a multicast physical downlink control channel (PDCCH) communication for the inactive mode;
receiving a configuration associated with the multicast PDCCH communication;
receiving the multicast PDCCH communication in accordance with the configuration; and
receiving the multicast PDSCH communication in the inactive mode based at least in part on the multicast PDCCH communication, wherein at least one of the configuration, or the multicast PDSCH communication is based at least in part on the capability information.

27. The method of claim 26, wherein the configuration associated with the multicast PDCCH communication indicates a configuration of a control resource set (CORESET) configured in a multicast common frequency resource (CFR), and wherein the method further comprises:
monitoring, in the inactive mode, the CORESET in the multicast CFR and at least one CORESET selected from:
a CORESET zero for system information, paging, or broadcast, or
a CORESET configured by a system information block 1 (SIB1), or
a CORESET configured for broadcast.

28. The method of claim 27, wherein monitoring the CORESET in the multicast CFR further comprises monitoring the CORESET in the multicast CFR, the CORESET zero, and at least one other CORESET in the inactive mode.

29. A method of wireless communication performed by a network node, comprising:
outputting a multicast physical downlink control channel (PDCCH) communication for a user equipment (UE) in accordance with a configuration associated with the multicast PDCCH communication; and
outputting a multicast physical downlink shared channel (PDSCH) communication for the UE in an inactive mode based at least in part on the multicast PDCCH communication, wherein at least one of the configuration, or the multicast PDSCH communication is based at least in part on capability information associated with the UE and regarding at least one of the multicast PDSCH communication for an inactive mode or the multicast PDCCH communication.

30. The method of claim 29, wherein the capability information indicates a number of multiple-input multiple-output (MIMO) layers for the multicast PDSCH communication or a modulation scheme for the multicast PDSCH communication for the inactive mode, and wherein the number of MIMO layers or the modulation scheme is less than or equal to a number of MIMO layers or a modulation scheme for a connected mode.
